(19) United States
(12) Patent Application Publication
(10) Pub. No.: US 2006/0095312 A1
(43) Pub. Date: May 4, 2006

(54) Method, system, and storage medium for using comparisons of empirical system data for testcase and workload profiling

(75) Inventors: Thomas W. Conti, Poughkeepsie, NY (US); Geoffrey E. Miller, Highland, NY (US); Richard D. Prewitt, Poughkeepsie, NY (US); Terri M. Menendez, Morgan Hill, CA (US)

Correspondence Address: CANTOR COLBURN LLP-IBM POUGHKEEPSIE, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 10/976,586

(22) Filed: Oct. 28, 2004

(51) Int. Cl. G06F 17/30

(52) U.S. Cl. 705/10

(57) ABSTRACT

Systems and methods for using comparisons of empirical system data, (e.g., performance, accounting, software module or function frequency), for testcase and workload profiling are provided. Instead of asking a customer what he does, simply asking for some set of empirical data that can be formatted, reduced, and analyzed. By gathering the same kind of data for the test systems that is used by the customer, testcases and workload profiling are improved by making comparisons between the customer data and the test data in an iterative process. The iterative processes change test data and compare not only customer data with test data but also compare data from prior iterations with current data. There is a feedback loop for providing a comparison of how close or distant the testcases and workload profiling are from customer-like data and workloads in a particular test.

### BACKGROUND OF THE INVENTION

1. Field of the Invention

The present invention relates generally to software testing and, in particular, to software testing across platforms and operational profiling.

2. Description of Related Art

There is a need for improvement in the current operational profiling art, where external activity distributions map to testcase distribution. Operational profiling, or profiling for short, is a kind of software testing. Profiling includes measuring, collecting, and analyzing data about activity levels occurring in a software system. The data collected is called a profile. Examples of activity levels include a level of file accesses in a file management system and a level of messages transmitted in a messaging system. Profiling needs to be extended to include both external and internal activities, i.e., activities that are external or internal to a software system.

Operational profiling often is limited to a vague understanding of a customer's workload activities, with no valid feedback loop to demonstrate that the measurement of external workload activities of a given customer's workload map well to a test workload for both the external interfaces and the internal processing. Currently, there is no defined process to understand the internal activities of a workload for a set of components, a component, a sub-component, or an application. Sometimes, the customer is queried to gain an understanding of what externals are exercised and to determine the overall distribution of the external activities. Sometimes, there is an understanding of the industry average for some particular solution.

Consider a shopping application. Suppose an ecommerce application supplies an infrastructure for building an online store or mall. Sometimes, a customer is queried to understand if they are using certain features, such as business-to-business (B2B), business-to-consumer (B2C), auctioning or the like. Numbers are sometimes obtained from the customer about how the shopping site is stressed with regard to the distribution of catalog browsing, adding items to a shopping cart, entering personal information to complete a sale, or actually completing a sale to make a purchase. Other times, this type of external activity distribution is obtained from an industry-wide average from public or common knowledge. Thus, testing is primarily based on externals from customer or industry input. But, there is no measure of whether or not a test system is being driven in a similar or more comprehensive fashion with regard to internal portions of code being executed in the customer system.

There is a need for a way to understand internal processing of a software system and to collect a set of empirical data points from both the customer and the test environment. The empirical data points would allow accurate measurements and comparisons of how close or distant the test environment is from providing a similar or better measure of load and coverage than the customer environment. With the measurements and comparisons, new test workloads could be created and existing test workloads could be modified to be more closely aligned with customer workloads. There is a need for a way to build a portfolio of workloads and environment tuning actions, allowing load and stress testing to be focused on a particular customer or a composite for an industry or workload type. This would certainly be a much more cost effective approach to customer representative testing than the often suggested and very costly porting of customer workloads into the test environment. For example, a single test workload could cover all of the customers.

There is a need for gathering empirical system data and having conditions in the test environment similar to the customer environment when resolving customer problem reports. Empirical system data, (e.g., activity at a component level, the number of direct access requests, the number of sequential access requests), would provide more detailed information than external indicators and improve the quality and effectiveness of software testing during resolution of customer problem reports. There is also a need for providing some kind of comparison charts or other data to reassure the customer that any resolution was tested under conditions similar to the customer environment.

### BRIEF SUMMARY OF THE INVENTION

The present invention is directed to systems and methods of comparing empirical system data for testcase and workload profiling that satisfies these needs and others.

A first aspect is a method of comparing empirical system data for testcase and workload profiling. Customer data is gathered from a customer system and test data is gathered from a test system. The test data corresponds to the customer data. The test system including testcases and workloads. At least one testcase or at least one workload in the test system is improved by making comparisons between the customer data and the test data in an iterative process.

A second aspect is another method for using comparisons of empirical system data for testcase and workload profiling. Customer data is received from a customer system. The customer data includes a plurality of customer activities. Test data is gathered from a test system. The test system includes a plurality of testcases and a plurality of workloads. The test data includes a plurality of test activities. Each test activity in the test activities corresponds to a customer activity in the customer activities. It is determined whether a select test activity meets or exceeds the corresponding customer activity. A workload in the test system is changed and new test data is gathered, when the select test activity does not meet or exceed the corresponding customer activity.

A third aspect is a system for using comparisons of empirical system data for testcase and workload profiling. The system includes a customer system and a test system. The customer system provides customer data that includes a plurality of customer activities. The test system provides test data that includes a plurality of testcases and a plurality of workloads. The test data includes a plurality of test activities. Each test activity corresponds to a customer activity. The test system changes a workload in the test system and gathers new test data, when a select test activity does not meet or exceed a corresponding customer activity.

### BRIEF DESCRIPTION OF THE DRAWINGS

These and other features, aspects, and advantages of the present invention will become better understood with regard to the following description, appended claims, and accompanying drawings, where:

FIG. 1 shows a flow chart of an exemplary method for using comparisons of empirical system data for testcase and workload profiling;

FIG. 2 is a block diagram of an exemplary data analysis system;

FIG. 3 is a block diagram of an exemplary customer system;

FIG. 4 is a block diagram of an exemplary test system;

FIG. 5 is a block diagram of another exemplary data analysis system;

FIG. 6 is a block diagram of another exemplary customer system;

FIG. 7 is a block diagram of another exemplary test system;

FIGS. 8, 9, 10, and 11 are exemplary charts comparing activity levels resulting from customer and test data, before performing the exemplary method; and

FIGS. 12, 13, 14, and 15 are exemplary charts comparing activity levels resulting from customer data and improved workload data, after performing the exemplary method.

### DETAILED DESCRIPTION OF THE INVENTION

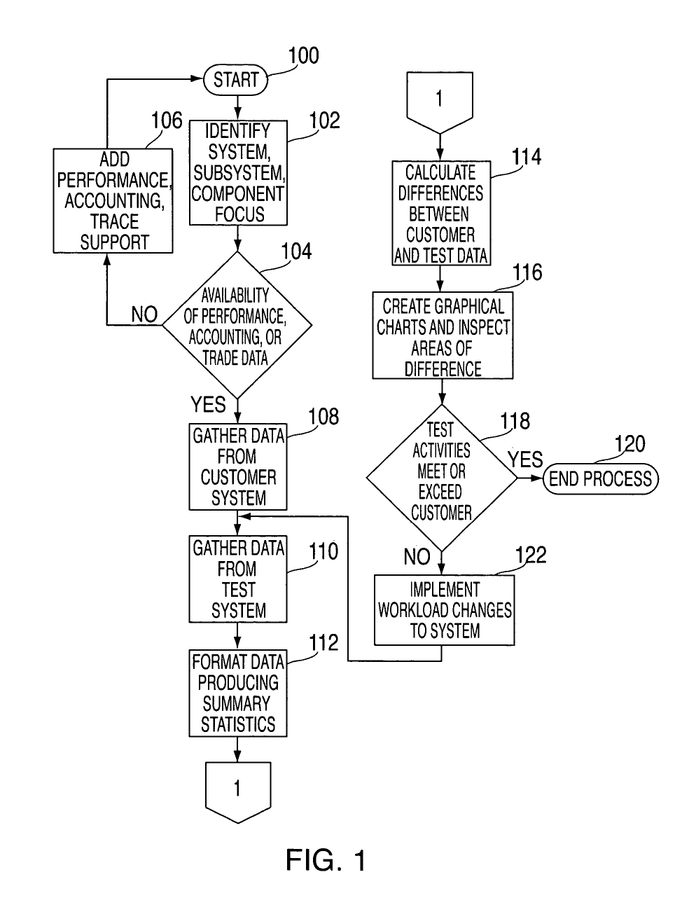

FIG. 1 shows a flow chart of an exemplary method for using comparisons of empirical system data for testcase and workload profiling. The method begins at the start 100, by identifying a system, subsystem, and component focus for testing at 102. The availability of performance, accounting, or trace data is determined at 104. If such data is not available, performance, accounting, and trace support is added at 106. Otherwise, data is gathered from the customer system at 108 and data is gathered from the test system at 110. Data is formatted to produce summary statistics at 112. Then, differences are calculated between the customer and test data at 114, using the statistical data and other analysis for selected data points. Graphical charts are created and areas of difference are inspected at 116. If the test activities meet or exceed the customer's test activities at 118, the process ends at 120. Otherwise, workload changes to the test system are implemented at 122 and control loops back to gather data from the test system at 110. In this way, the testcases and workload profiling are changed iteratively until the test activities meet or exceed the customer's test activities at 118. This judgment is made in light of the testing purposes and goals and may only consider selected test activities. Multiple changes may be made during iterations.

The exemplary method for using comparisons of empirical system data for testcase and workload profiling improves the current art of asking the customer what he does by simply asking for some set of empirical data that can be formatted, reduced, and analyzed. After gathering the same data from the test system, a comparison is made with the customer data and this comparison is used in an iterative process. The iterative process is one of test workload changes followed by data comparisons to both the customer data and to data in prior iterations. In this way, a more representative workload and/or environment tuning is achieved. A more representative workload is not necessarily optimal. It may be suboptimal or not recommended. The goal is to have the test environment be representative of the customer environment in order to do testing that successfully removes defects. Workloads can be modified or created with a concept of future tuning capabilities designed in so that the test workload portfolio represents individual workloads. These individual workloads can be used every day with variability to enable testing of both the products and the service streams with workloads that exceed the customer's activity, best fits a set of customers, or generally matches an industry composite.

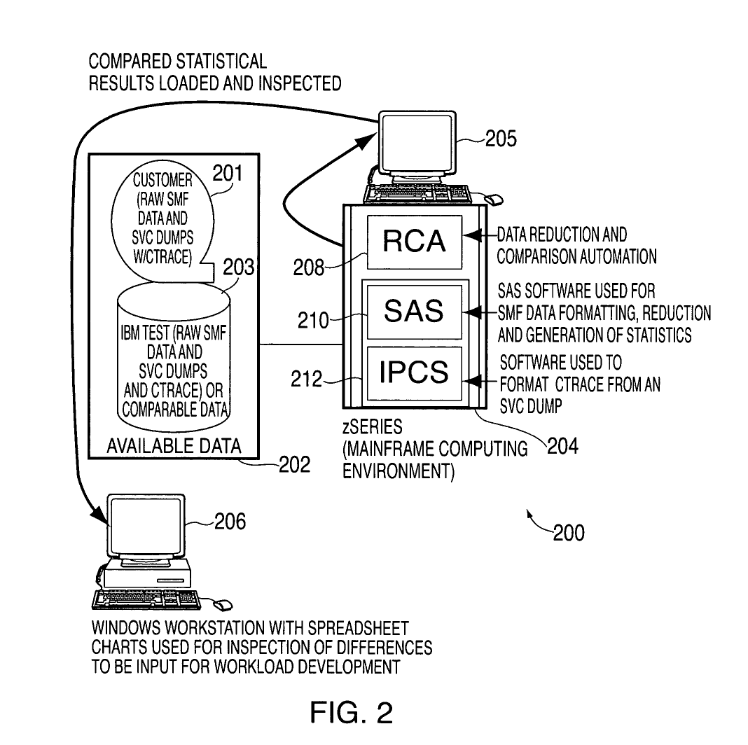

FIG. 2 shows an exemplary data analysis system 200. In this exemplary data analysis system 200 available data 202 is accessible to a computing environment 204, such as a zSeries™ mainframe computing environment. After processing, compared statistical results are loaded and inspected at a computer 206, such as a Windows™ workstation with spreadsheet charts. The spreadsheet charts are used for inspection of differences to be input for workload development and to provide to customers. A computer 205 is running an emulator session with access to programs and information in the computing environment 204. Computer 205 may be the same as computer 206.

The available data 202 includes customer data 201 and test data 203. The exemplary data analysis system records or otherwise obtains empirical system data for testcase and workload profiling to be used in comparisons. The exemplary data analysis system records performance and accounting data, such as system management facility (SMF) data, component trace (CTRACE) data, and list catalog (LISTCAT) data. However, there is no limitation on what data, hardware or software platforms can be used. Testcase and workload profiling can be improved even by bringing a single data point closer to the customer's data. SMF, CTRACE, LISTCAT, or any other data is collected at both the customer system and the test system.

After the available data 202 is collected, it is reduced and averages, minimums, maximums, standard error, and other statistics are computed for data points over periods of measurement. The statistics are then mapped and compared to one another and workload alterations and tuning are implemented to converge the data in the comparisons. With CTRACE, module call frequency statistics are used to understand the amount and type of work being completed during a very small measurement window.

Computing environment 204 includes a data reduction and comparison automation (RCA) 208, statistical analysis software (SAS® software) 210, and IPCS 212, in this exemplary data analysis system 200. SAS 210 provides statistical data for the SMF data, in this example. IPCS 212 formats the CTRACE data, in this example. RCA 208 requests and receives the statistical data from SAS 210 and the formatted data from IPCS 212. RCA 208 filters the data, compares test data and customer data, and determines the differences between the test data and the customer data, such as a percent difference.

Exemplary statistics for a single data point generated and compared for two sets of mined data is shown in Table 1. This sample is from one of 202 data points from an SMF type 42, subtype 15, Sysplex-wide storage class summary data section. The data is collected over several SMF recording intervals and the statistics are programmatically generated.

TABLE 1
Exemplary statistics.

| Variable | Type | Customer Data | Test Data | Difference | % Difference |
|---|---|---|---|---|---|
| SMF42FCB | Min | 0 | 2876432 | 2876432 | 100 |
| SMF42FCB | Max | 747834 | 3211048 | 2463214 | 329.37978 |
| SMF42FCB | Mean | 85228.2 | 3081167.6 | 2995939.4 | 3515.1974 |
| SMF42FCB | Std Error | 148713.81 | 118643.87 | −30069.94 | −20.22001 |

In Table 1, the customer data is more varied, while the test data is more steady state as shown by the difference between minimum and maximum values and the standard deviation. Conclusions are drawn and test data is modified based on analysis of the statistics according to the testing purposes or goals. For example, the percent difference indicates a degree of similarity between the customer data and the test data. A negative percent difference indicates missing activity in the test. A large positive percent difference indicates that the test exceeds the customer for “good” activity, but for “bad” activity this indicates a need for changes to the test system.

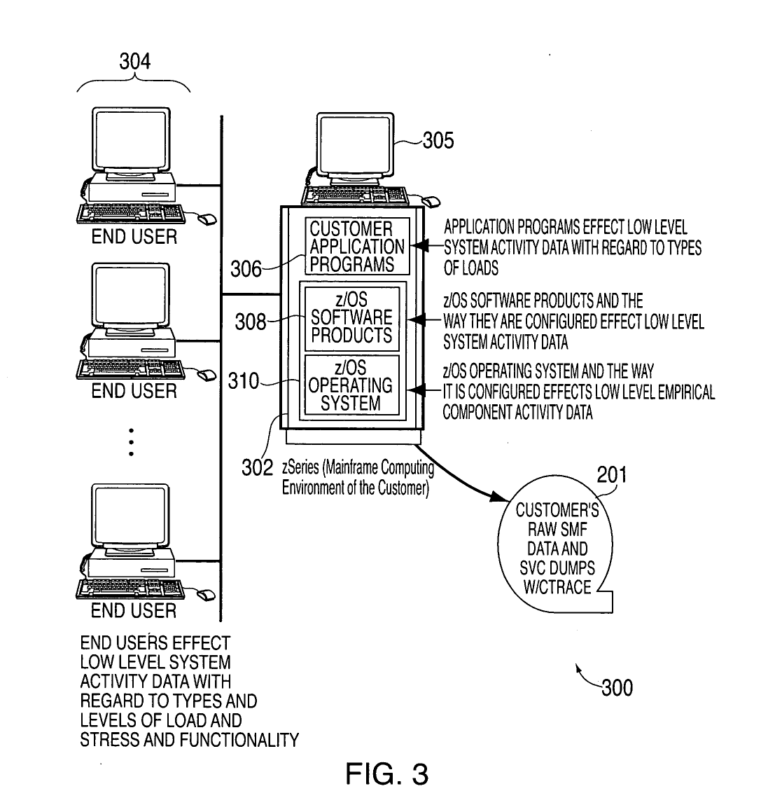

FIG. 3 shows an exemplary customer system 300. The exemplary customer system 300 includes the customer computing environment 302 and a number of end users 304. The customer computing environment 302 is the zSeries™ mainframe, in this example. The end users 304 effect low-level system activity data with regard to types and levels of load and stress and functionality.

The customer computing environment 302 includes a computer 305, customer application programs 306, a z/OS™ software products 308, and a z/OS™ operating system 310, in this example. The customer application programs 306 effect low-level system activity data with regard to types of load and stress. Some examples of customer application programs 306 include financial software applications, banking software applications, and any application that drives low-level system activity. The z/OS™ software products 308 and the way they are configured effect low level system activity data. The Z/OS™ operating system 310 and the way it is configured effects low-level empirical component activity data. The customer computing environment 302 also collects the low level system activity as customer data 201, i.e., the customer's raw SMF data and/or Supervisor Call (SVC) dumps with CTRACE, in this example.

The customer data 201 in the customer-computing environment 302 of FIG. 3 is the same as the customer data 201 in the exemplary data analysis system 200 of FIG. 2. Customer data 201 is provided to a testing facility on a tape or some other medium or by another method.

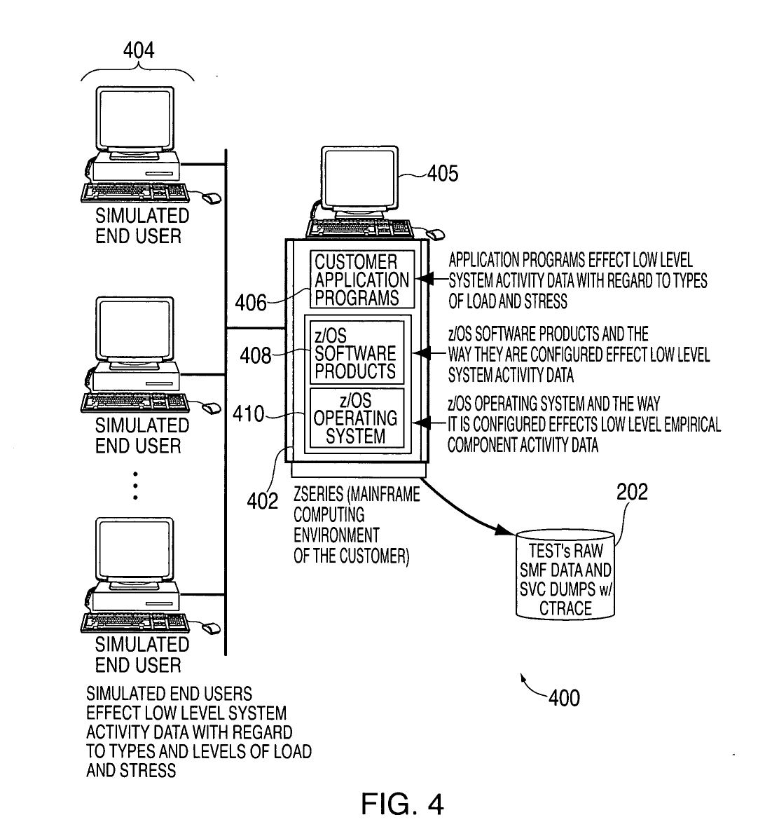

FIG. 4 shows an exemplary test system 400. The exemplary test system 400 includes a test computing environment 402 and simulated end users 404.

The exemplary test computing environment 402 includes a computer 405, test application programs 406, z/OS™ software products 408, z/OS™ operating system 410, and test data 202. The test application programs 406 effect low-level system activity data with regard to types of load and stress. The z/OS™ software products 408 and the way they are configured effect low level system activity data. The z/OS™ operating system 410 and the way it is configured effects low-level empirical component activity data. The low-level system activity data is collected in a database as the test data 202 and available to the exemplary data analysis system 200 of FIG. 2.

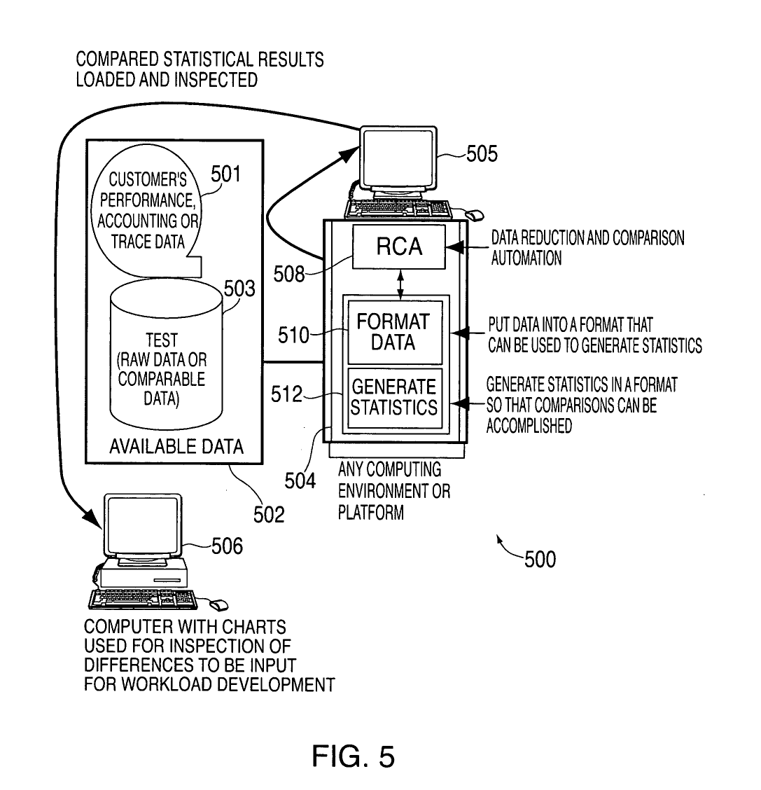

FIG. 5 shows another exemplary data analysis system 500, which may be any computing system capable of performing data analysis. Unlike FIG. 2 that shows specific components, FIG. 5 has generic components. In this exemplary data analysis system 500 available data 502 is accessible to any computing environment or platform 504. After processing, compared statistical results are loaded and inspected at a computer 506 with charts that are used for inspection of differences to be input for workload development and to provide to customers. A computer 505 has access to programs and information in the computing environment 504. Computer 505 may be the same as computer 506.

The computing environment 504 includes data reduction and comparison automation (RCA) 508, formatting data 510 and generating statistics 512. The RCA 508 may be the same program that formats data 510 and generates statistics 512 or they may be separate components.

The available data 502 includes customer data 501 and test data 503. The customer data 501 includes any performance, accounting, or trace data. The test data 503 includes any raw data or comparable data.

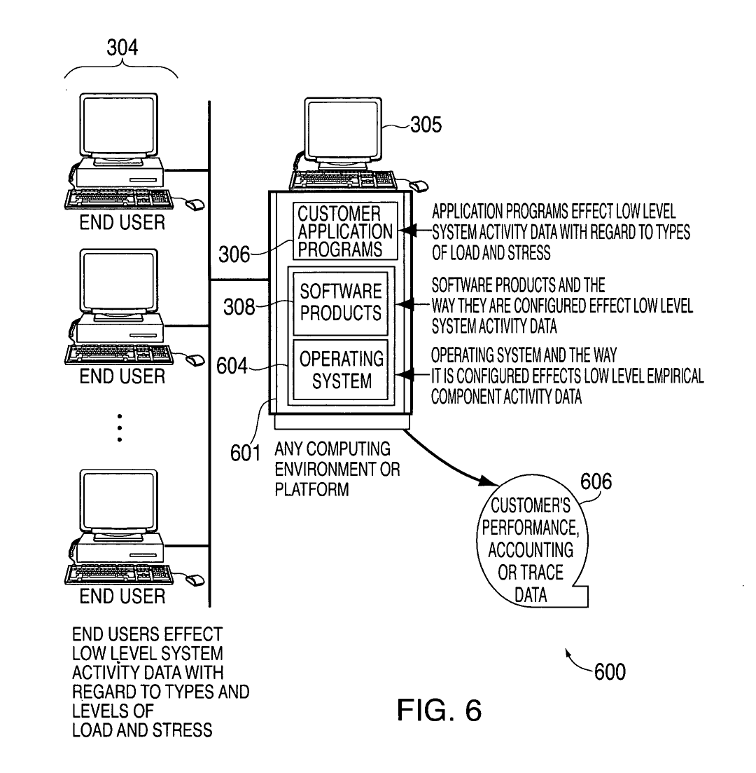

FIG. 6 shows another exemplary customer system 600. Unlike FIG. 3 that shows specific components, FIG. 6 has generic components. The exemplary customer system 600 includes any computing environment or platform 601, which includes any software products 602 and any operating system 604. There is no restriction on the customer application programs 306, computer 305, or end users 306. The customer application programs 306 effect low-level system activity data with regard to types of load and stress. The software products 602 and the way they are configured effect low-level system activity data. The operating system 604 and the way it is configured effects low-level empirical component activity data. All this low-level activity data is collected as the customer's performance, accounting or trace data 606, which may take any form.

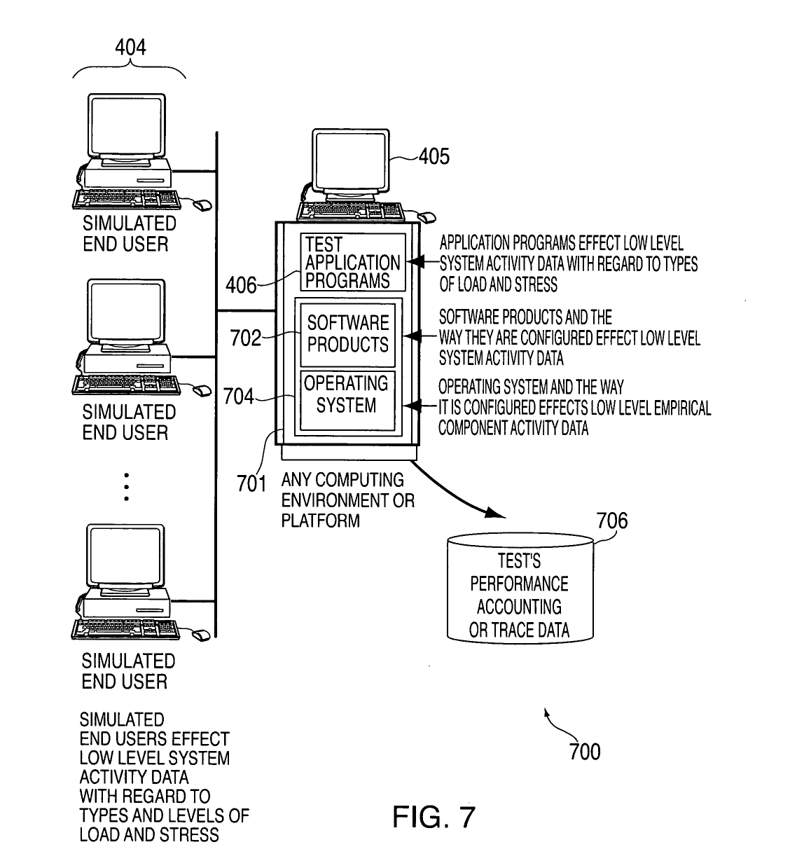

FIG. 7 shows another exemplary test system 700. Unlike FIG. 4 that shows specific components, FIG. 7 has generic components. The exemplary test system 700 includes any computing environment or platform 701, which includes any software products 702 and any operating system 704. There is no restriction on the test application programs 406 or simulated end users 404. The test application programs 406 effect low-level system activity data with regard to types of load and stress. The software products 702 and the way they are configured effect low-level system activity data. The operating system 704 and the way it is configured effects low-level empirical component activity data. All this low-level activity data is collected as the test's performance, accounting, or trace data 706, which may take any form.

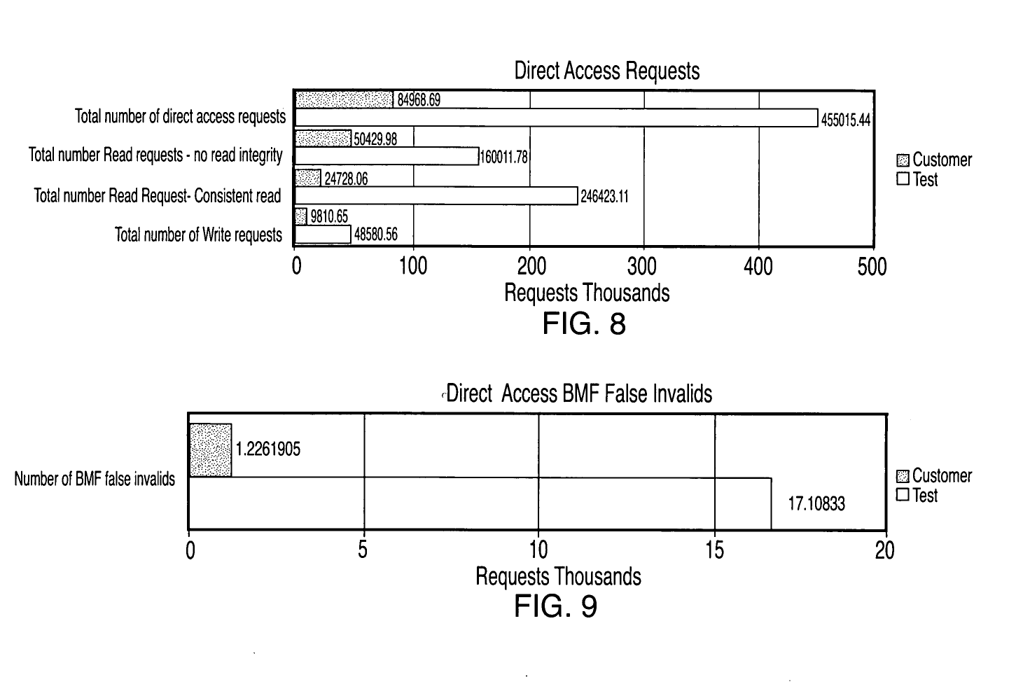

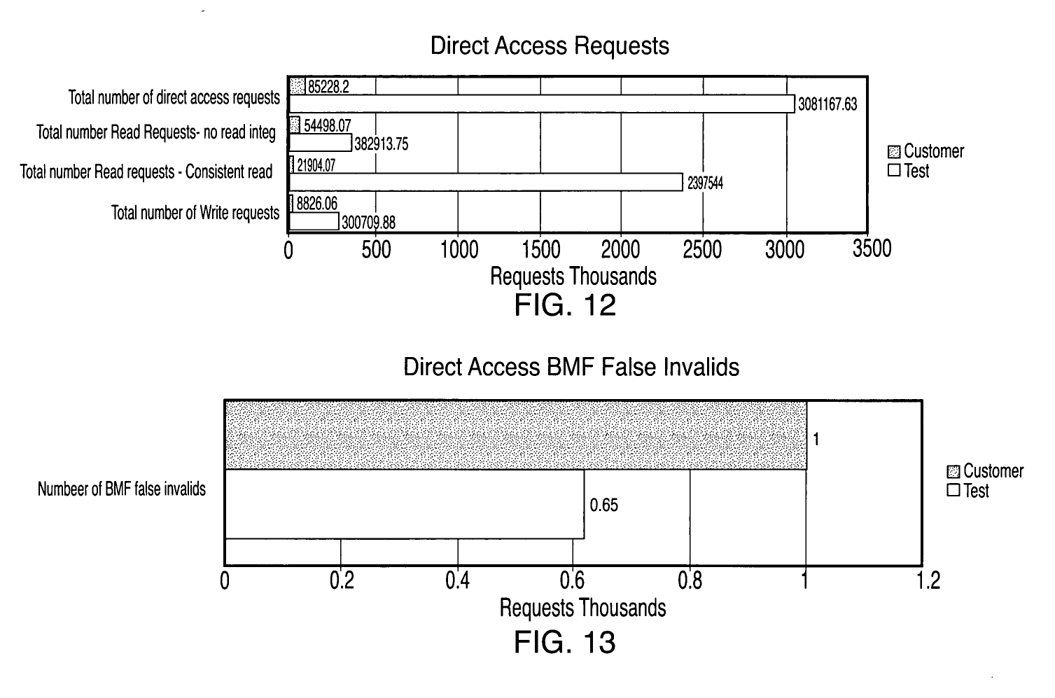

FIGS. 8-15 show exemplary test data to illustrate one way the exemplary method may be applied. FIGS. 8-11 show data before performing the exemplary method, while FIGS. 12-15 show data after performing the exemplary method. The software being tested was a software system using virtual sequential access method (VSAM)/record level sharing (RLS). Of course, the exemplary method is applicable to software tests, hardware tests, and any other kind of tests. In this example, some of the activities of concern were buffer management generally, caching, the response times for storage, the number of direct access requests, the number of sequential access requests, and many other activities. Data points were selected corresponding to these activities. In this example, there were about 2,000 data points for the VSAM/RLS workload. Low level, empirical system data was collected, rather than general, subjective problem reports.

In this example, there were two goals for analyzing the testing data collected. The first goal is to do at least the same amount or at best more of “good” processing to prove that the test environment is driving load and stress as heavy or much heavier than the customer. The second goal is to do some “bad” or costly processing for code coverage purposes, but not to run a performance challenged test that covers low probability code paths at much greater frequency than a customer would. Typically, those kinds of paths are not cost-effective to test.

FIGS. 8, 9, 10, and 11 show exemplary charts comparing activity levels resulting from customer data and test data, before performing the exemplary method. On the legend of this exemplary chart, the customer data is designated “Customer” and shown in darker shaded bars and the original test data is designated “Test” and shown in lighter shaded bars.

In FIG. 8, the direct access requests in the test data exceeded the customer data. The direct access requests did not need to be increased. (See FIG. 12.)

In FIG. 9, the test data had about 1.4 million percent more buffer invalidations than the customer data, resulting in costly I/O cycles. The buffer invalidations need to be reduced. (See FIG. 13.)

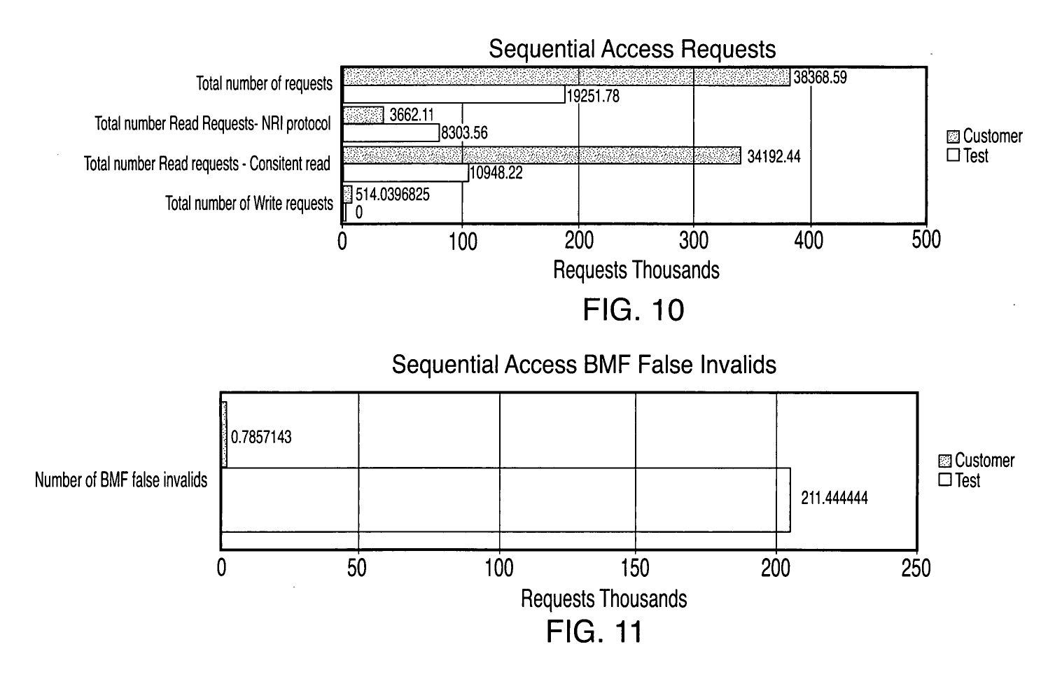

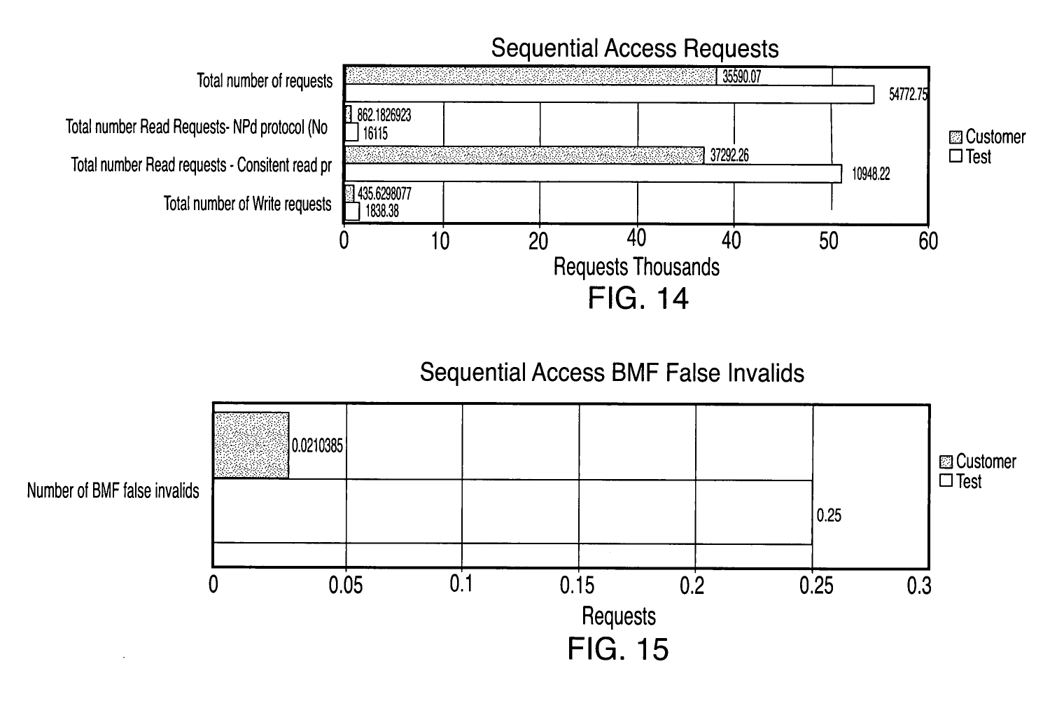

In FIG. 10, sequential access requests are low in the test cases and need to be improved or increased. (See FIG. 14.)

In FIG. 11, sequential access buffer invalidations are high, but not as great a performance impact as the direct access buffer invalidations. The direct access buffer invalidations need to be reduced. (See FIG. 15).

FIGS. 12, 13, 14, and 15 show exemplary charts comparing activity levels resulting from customer data and improved workload data, after performing the exemplary method. On the legend of these exemplary charts, the customer data is designated “Customer” and shown in darker shaded bars and the improved workload data is designated “Test” and shown in lighter shaded bars. Some of the test workload changes resulting from the exemplary method for using comparisons of empirical system data for testcase and workload profiling are listed below.

Updated the size of a coupling facility (CF) caching structure to prevent costly buffer invalidation that was observed in a first iteration of the exemplary method applied to the customer data and the original test data. The results included a large reduction of the costly buffer invalidation, which improved several correlated data points. The correlated data points included more overall requests, lower normalized response time, and more I/O requests to a cache manager and less I/O requests to a direct access storage device (DASD).

Updated the size of a control interval (CI) for VSAM files to avoid too large a frequency of both CI and control area (CA) split processing. Split processing is an I/O intensive process that the test environment was doing too great an amount of over short periods of time.

Activated a hotel reservation transaction that includes sequential updates (readnext and update). Previously, the test environment had none of this specific type of activity. This change improved the overall sequential access requests so that they exceeded the levels demonstrated by the customer data.

Ran a greater number of virtual users (3,000 originally, 5,000 finally). This widened the gap of activity, giving the test systems a lead in overall activity.

These changes improved the test data to be more like the customer data. The statistical data analysis feedback loop also demonstrates that the changes had a positive impact in the testing activities, including service integration tests.

FIG. 12 shows an increase in direct access requests for the test environment, after changes were made. Even though the testing was already exceeding the customer activity for these data points, the new tests do even more than before, which meets the testing goal of creating greater stress for the “good” processing. (See FIG. 8.)

FIG. 13 shows that direct access BMF false invalidation dropped dramatically, improving statistics for many data points. (See FIG. 9.)

FIG. 14 shows that sequential access requests went from less than the customer data to more than the customer data, which was the desired result. (See FIG. 10.)

FIG. 15 shows that sequential access BMF false invalidations were also significantly reduced. (See FIG. 11.)

Applying the exemplary method for using comparisons of empirical system data for testcase and workload profiling usually will not result in identical activity levels for customer data and test data. Generally for most “good” processing, it is better to do more activity for stress testing, because that is most likely to reveal problems to fix. For example, if an automobile manufacturer expected customers to drive at 80 mph, it would be a good idea to test-drive it at 100 mph.

An exemplary tool performs the exemplary method for using comparisons of empirical system data for testcase and workload profiling. Test data and customer data are received, compared, and statistically analyzed, and reports are produced. An exemplary report includes charts comparing activity levels resulting from customer data and workload data, both before and after performing the exemplary method. The exemplary tool is one or more software programs.

The exemplary embodiments of the present invention have many advantages. One advantage that tests become more representative and data can be provided to support and prove that a test is more representative of the customer's internal activities and rates with hard data. Without having objective data, it is difficult to determine how to bring the test data into greater alignment with the customer data. Another advantage is that the exemplary method includes a feedback loop to provide factual data that shows by comparison how close or distant testing is from running customer-like workloads. Yet another advantage is that a simple or complex change can be made to a test workload and the overall effect can be measured as positive or negative in comparison to either the customer data or previous iterations of changes to the test workload. Still another advantage is that customers feel more secure when they understand that the test workloads are made more representative by reviewing charts and other reports.

As described above, the embodiments of the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. For example, not only z/OS™, but any type of operating system may be used and not only zSeries™ mainframes, but any type of computing devices may be used. Furthermore, various components may be implemented in hardware, software, or firmware or any combination thereof. Finally, many modifications may be made to adapt a particular situation or material to the teachings of the invention without departing from the essential scope thereof. Therefore, it is intended that the invention is not to be limited to the particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of comparing empirical system data for testcase and workload profiling, comprising:
gathering customer data from a customer system;
gathering test data from a test system corresponding to the customer data, the test system including testcases and workloads;
improving at least one testcase or at least one workload in the test system by making comparisons between the customer data and the test data in an iterative process.

2. The method of claim 1, further comprising:
comparing data from a prior iteration with data in a current iteration.

3. The method of claim 1, further comprising:
providing a comparison of how close or distant the at least one testcase and the at least one workload are from the customer data.

4. The method of claim 1, further comprising:
formatting, reducing, and analyzing the customer data.

5. A method for using comparisons of empirical system data for testcase and workload profiling, comprising:
receiving customer data from a customer system, the customer data including a plurality of customer activities;
gathering test data from a test system, the test system including a plurality of testcases and a plurality of workloads, the test data including a plurality of test activities, each test activity in the test activities corresponding to a customer activity in the customer activities;
determining whether a select test activity meets or exceeds the corresponding customer activity; and
changing a workload in the test system and gathering new test data, when the select test activity does not meet or exceed the corresponding customer activity.

6. The method of claim 5, further comprising:
performing a statistical analysis of a comparison of the customer data and the test data.

7. The method of claim 6, further comprising:
calculating differences between the customer data and the test data based on the statistical analysis.

8. The method of claim 7, further comprising:
creating charts indicating the differences.

9. The method of claim 5, further comprising:
changing a testcase in the test system and gathering new test data, when the test activity does not meet or exceed the corresponding customer activity.

10. The method of claim 5, wherein changes are made in a plurality of workloads in the test system and new test data is gathered, until each test activity meets or exceed the corresponding customer activity.

11. The method of claim 10, further comprising:
performing a statistical analysis of a comparison of the customer data and the new test data;
calculating differences between the customer data and the new test data based on the statistical analysis; and
creating charts indicating the differences.

12. A system for using comparisons of empirical system data for testcase and workload profiling, comprising:
a customer system for providing customer data, the customer data including a plurality of customer activities;
a test system for providing test data, the test data including a plurality of testcases and a plurality of workloads, the test data including a plurality of test activities, each test activity in the test activities corresponding to a customer activity in the customer activities;
wherein the test system changes a workload in the test system and gathers new test data, when a select test activity does not meet or exceed a corresponding customer activity.

13. The system of claim 12, further comprising:
a data analysis system for performing a statistical analysis of a comparison of the customer data and the test data.

14. The system of claim 12, wherein the data analysis system calculates differences between the customer data and the test data based on the statistical analysis.

15. The system of claim 14, wherein the data analysis system creates charts indicating the differences.

16. The system of claim 12, wherein the test system changes a plurality of workloads and provides new test data, until each test activity meets or exceed the corresponding customer activity.

17. A storage medium having instructions stored thereon to perform a method of comparing empirical system data for testcase and workload profiling, the method comprising:
gathering customer data from a customer system;
gathering test data from a test system corresponding to the customer data, the test system including testcases and workloads;
improving at least one testcase or at least one workload in the test system by making comparisons between the customer data and the test data in an iterative process.

18. A storage medium having instructions stored thereon to perform a method for using comparisons of empirical system data for testcase and workload profiling, the method comprising:
receiving customer data from a customer system, the customer data including a plurality of customer activities;
gathering test data from a test system, the test system including a plurality of testcases and a plurality of workloads, the test data including a plurality of test activities, each test activity in the test activities corresponding to a customer activity in the customer activities;
determining whether a select test activity meets or exceeds the corresponding customer activity; and
changing a workload in the test system and gathering new test data, when the select test activity does not meet or exceed the corresponding customer activity.
